(19) United States
(12) Patent Application Publication
(10) Pub. No.: US 2026/0051431 A1
(43) Pub. Date: Feb. 19, 2026

(54) COIL COMPONENT

(71) Applicant: TDK Corporation, Tokyo (JP)

(72) Inventors: Shinnosuke SUZUKI, Tokyo (JP); Kazuya Tobita, Tokyo (JP); Munehiro Takaku, Tokyo (JP); Tomohiro Kaito, Tokyo (JP)

(73) Assignee: TDK Corporation, Tokyo (JP)

(21) Appl. No.: 19/296,170

(22) Filed: Aug. 11, 2025

(30) Foreign Application Priority Data
Aug. 13, 2024 (JP) 2024-135052

(51) Int. Cl. H01F 17/00; H01F 27/32

(52) U.S. Cl. CPC H01F 17/0013; H01F 27/323

(57) ABSTRACT

In a coil component, there exist a first region where an adhesive layer of a wiring portion and an element layer are in direct contact with each other and a second region where a main body of the wiring portion and the element layer are in direct contact with each other in a cross section orthogonal to the extending direction of the wiring portion, even when the electrical resistivity of the adhesive layer is higher than that of the main body, the electric resistance caused by a high-frequency current due to the skin effect is reduced, whereby a high self-resonant frequency can be realized.

### CROSS-REFERENCE TO RELATED APPLICATIONS

This application is based upon and claims the benefit of priority from Japanese Patent Applications No. 2024-135052, filed on 13 Aug. 2024, the entire content of which is incorporated herein by reference.

### TECHNICAL FIELD

The present disclosure relates to a coil component.

### BACKGROUND

Japanese Patent Application Publication No. 2014-232815 discloses a coil component including an element body having a laminated structure composed of a plurality of insulating layers, and a coil conductor provided in the element body, and a wiring portion (for example, a strip-shaped conductor) constituting the coil conductor is formed by plating.

### SUMMARY

The inventors have found that an adhesive layer interposed between a main body of a wiring portion of a coil conductor and an insulating layer constituting an element body increases the adhesive force between the wiring portion and the insulating layer. However, in the case that the electrical resistivity of the adhesive layer is higher than that of the main body, when the coil component is applied to a high-frequency circuit, a high-frequency current tends to flow through the adhesive layer with high electrical resistivity due to the skin effect, thereby it is likely to occur a decrease in the self-resonant frequency.

According to aspects of the present disclosure, a coil component having an improved self-resonant frequency is provided.

A coil component according to one aspect of the present disclosure includes an element body including a plurality of laminated insulating layers, and a coil conductor provided in the element body and including a wiring portion extending in a direction orthogonal to a lamination direction of the element body and overlapping a first insulating layer of the plurality of insulating layers in the lamination direction. The wiring portion has a main body and an adhesive layer interposed in a part of an interface between the main body and the first insulating layer in a cross section orthogonal to the extending direction, and there exist a first region and a second region. The adhesive layer and the first insulating layer are in direct contact with each other in the first region. The main body and the first insulating layer are in direct contact with each other in the second region.

In the above coil component, in a cross section of the wiring portion orthogonal to the extending direction, since there exist the first region where the adhesive layer and the first insulating layer are in direct contact with each other and the second region where the main body and the first insulating layer are in direct contact with each other, even if the electrical resistivity of the adhesive layer is higher than that of the main body, electrical resistance due to the high-frequency current caused by the skin effect is reduced, thereby realizing a high self-resonant frequency.

### BRIEF DESCRIPTION OF THE DRAWINGS

FIG. 1 is a perspective view of a coil component according to one embodiment.

FIG. 2 is a perspective view of the coil conductor shown in FIG. 1.

FIG. 3 is an exploded perspective view of the configuration of each layer of the coil component shown in FIG. 1.

FIG. 4 shows the configuration of the wiring portion of the first element layer shown in FIG. 3.

FIG. 5 is a cross-sectional view taken along line V-V of the second wiring portion shown in FIG. 4.

FIG. 6 shows the configuration of the wiring portion of the second element layer shown in FIG. 3.

FIG. 7 shows the configuration of the wiring portion of the third element layer shown in FIG. 3.

FIG. 8 is a cross-sectional view taken along line VIII-VIII of the first wiring portion shown in FIG. 7.

FIG. 9 shows the configuration of the wiring portion of the fourth element layer shown in FIG. 3.

FIG. 10 shows the configuration of the wiring portion of the fifth element layer shown in FIG. 3.

FIG. 11 is a flowchart of the procedure of the method for manufacturing the coil component shown in FIG. 1.

FIG. 12 is a side view of the coil component shown in FIG. 1.

### DETAILED DESCRIPTION

Hereinafter, embodiments of the present disclosure will be described in detail with reference to the accompanying drawings. In the description of the drawings, the same or corresponding element is denoted by the same reference numeral, and redundant description is omitted.

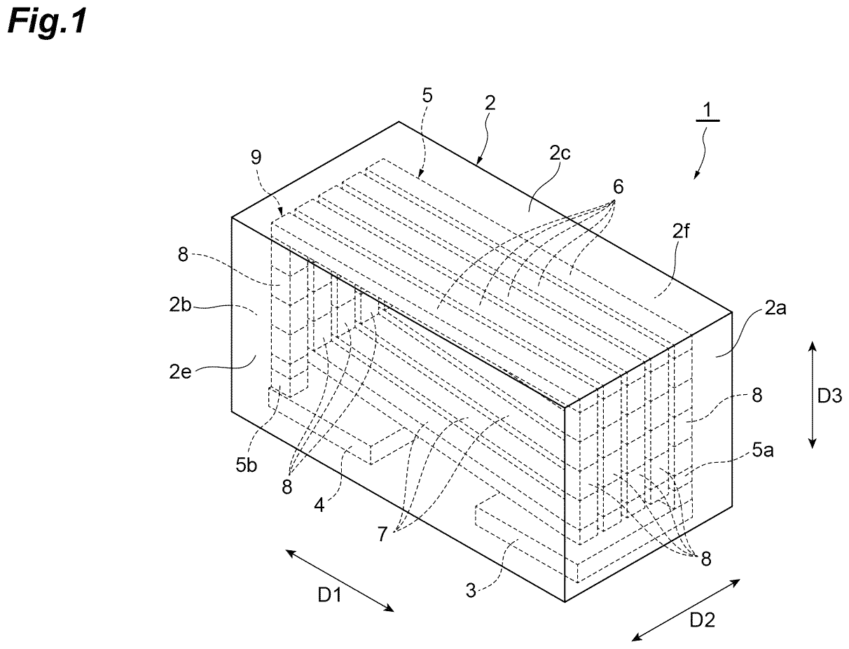

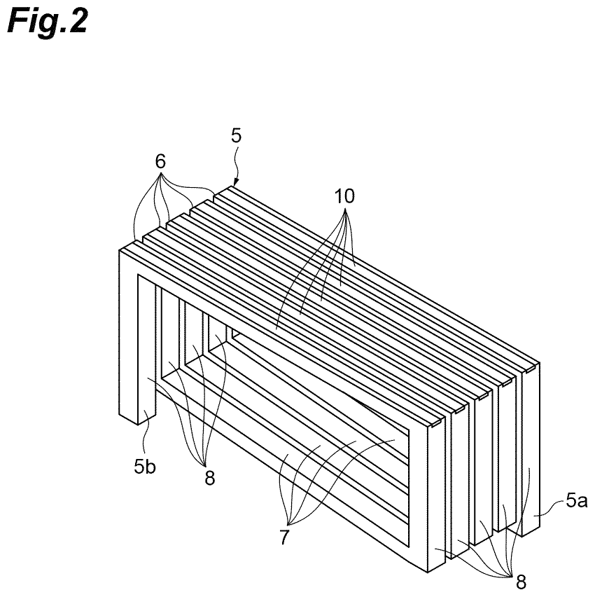

A coil component according to the present embodiment will be described with reference to FIG. 1. As shown in FIGS. 1 and 2, a coil component 1 according to one embodiment includes an element body 2, a pair of bottom electrodes 3 and 4, and a coil conductor 5. The coil conductor 5 is provided in the element body 2 and includes a plurality of second wiring portions 6, a plurality of pairs of pillar portions 8, and a plurality of first wiring portions 7, as will be described later. In particular, the coil conductor 5 includes five of the second wiring portions 6, five pairs of the pillar portions 8, and four of the first wiring portions 7. The coil conductor 5 has a coil axis along a second direction D2 to be described later, and is wound around the coil axis. The coil conductor 5 according to the present embodiment is wound around the coil axis by about 4.5 turns. The number of turns of the coil conductor 5 can be increased or decreased as appropriate. Accordingly, the number of the pairs of pillar portions 8, the number of the first wiring portions 7, and the number of the second wiring portions 6 may be increased or decreased.

The element body 2 has a rectangular parallelepiped shape. The rectangular parallelepiped shape includes a rectangular parallelepiped shape in which a corner portion and a ridge portion are chamfered or rounded. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, the facing direction of the end surfaces 2a and 2b is a first direction D1, the facing direction of the side surfaces 2e and 2f is a second direction D2, and the facing direction of the main surfaces 2c and 2d is a third direction D3. The first direction D1, the third direction D3, and the second direction D2 are substantially orthogonal to each other.

The end surfaces 2a and 2b extend in the third direction D3 to connect the main surfaces 2c and 2d. The end surfaces 2a and 2b also extend in the second direction D2 to connect the side surfaces 2e and 2f. The main surfaces 2c and 2d extend in the first direction D1 to connect the end surfaces 2a and 2b. The main surfaces 2c and 2d also extend in the second direction D2 to connect the side surfaces 2e and 2f. The side surfaces 2e and 2f extend in the first direction D1 to connect the end surfaces 2a and 2b. The side surfaces 2e and 2f also extend in the third direction D3 to connect the main surfaces 2c and 2d.

The main surface 2d is a mounting surface of the element body 2, and is, for example, a surface facing another electronic device when the coil component 1 is mounted on another electronic device (not shown) (for example, a circuit substance or a laminated electronic component). The end surfaces 2a and 2b are continuous surfaces from the mounting surface (i.e., the main surface 2d).

The length of the element body 2 in the first direction D1 is longer than the lengths of the element body 2 in the third direction D3 and the second direction D2. The length of the element body 2 in the third direction D3 is shorter than the length of the element body 2 in the second direction D2. That is, in the present embodiment, each of the end surfaces 2a and 2b, the main surfaces 2c and 2d, and the side surfaces 2e and 2f has a rectangular shape. The length of the element body 2 in the third direction D3 may be comparable with the length of the element body 2 in the second direction D2 or may be longer than the length of the element body 2 in the second direction D2.

In the present embodiment, the term “comparable” may refer to a value including a slight difference or a manufacturing error within a predetermined range, in addition to being equal. For example, when values are included in a range of ±5% of an average value of the values, the values are defined as being comparable.

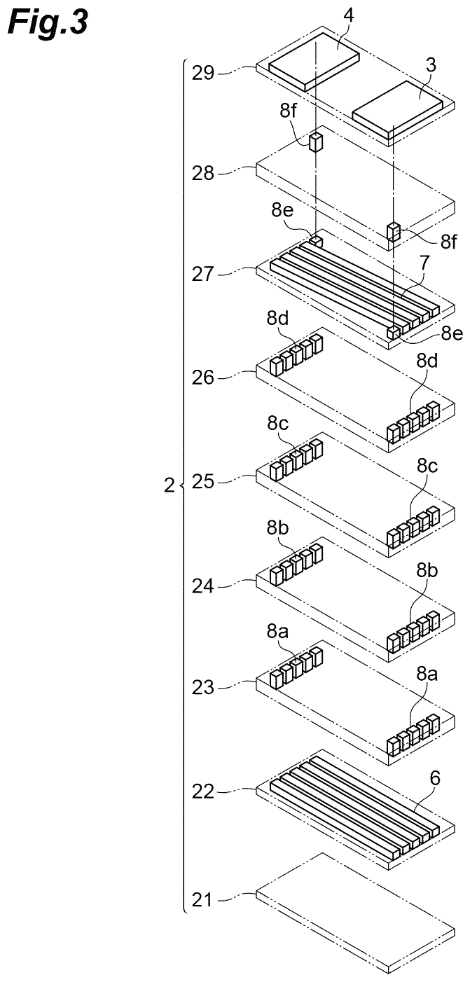

As shown in FIG. 3, the element body 2 has a configuration in which a plurality of element layers (insulating layers) are laminated in the third direction D3. In the present embodiment, the element body 2 is composed of nine of element layers 21 to 29. That is, the lamination direction of the element body 2 coincides with the third direction D3. The wiring portions 6 and 7 and wiring portions 8a to 8f constituting the coil conductor 5 are embedded in the element layers 22 to 28. As described in the manufacturing method below, the element body 2 can be manufactured by sequentially laminating the element layers 22 to 29 on the element layer 21. In the actual element body 2, the element layers 21 to 29 may be integrated so that the interface between the layers is visible or not visible to some extent.

Each of the element layers 21 to 29 is mainly composed of insulating material, for example, a resin material. The resin material includes, for example, at least one selected from a liquid crystal polymer, a polyimide resin, a crystalline polystyrene, an epoxy-based resin, an acrylic-based resin, a bismaleimide-based resin, and a fluorine-based resin. The resin material may be a light-transmitting material, and in this case, the element body 2 has light-transmitting properties, and the coil conductor 5 can be visually recognized from the outside of the element body 2. The resin material may or may not contain a filler. The filler is, for example, an inorganic filler. The inorganic filler is silica, for example. Each of the element layers 21 to 29 may be made of magnetic material. The magnetic material includes, for example, Ni—Cu—Zn-based ferrite material, Ni—Cu—Zn—Mg-based ferrite material, or Ni—Cu-based ferrite material. The magnetic material may include, for example, Fe alloy. Each of the element layers 21 to 29 may include non-magnetic material, which may be glass-ceramic material or dielectric material. Each of the wiring portions 6, 7, and 8a to 8f is composed of conductive material (for example, Cu).

The element layer 21 is composed only of the insulating material. The element layer 21 is located in the lowest layer of the element body 2 and constitutes the main surface 2c.

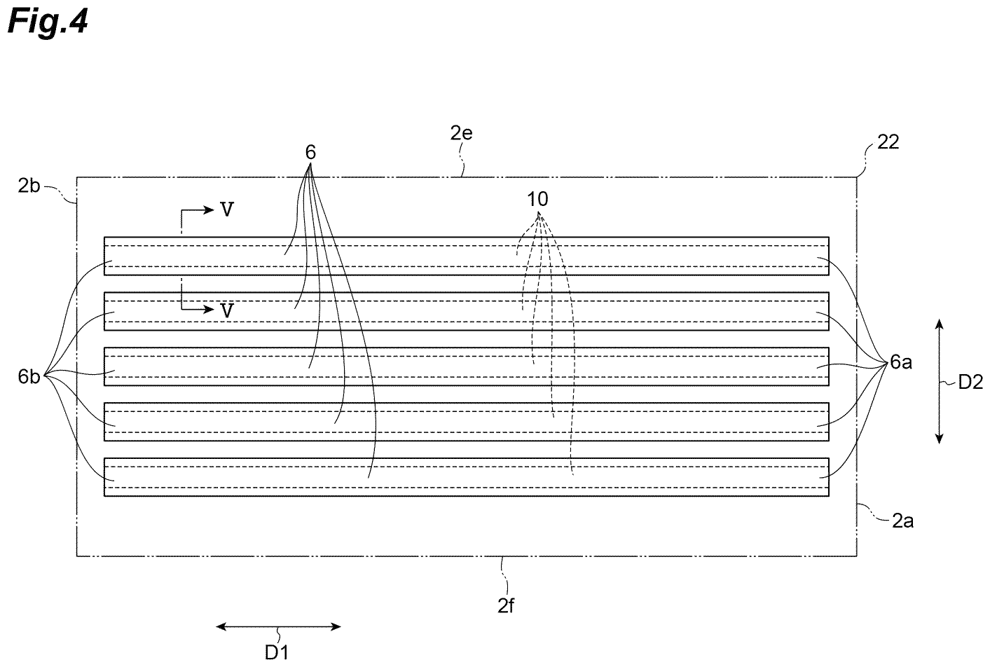

As shown in FIGS. 3 and 4, the second wiring portions 6 (lower wiring portions) are embedded in the element layer 22, and the element layer 22 according to the present embodiment includes five of the second wiring portions 6. Each of the second wiring portions 6 extends in parallel along the first direction D1 and has the same length with respect to the first direction D1. The second wiring portions 6 are equally spaced with respect to the second direction D2. The second wiring portions 6 are spaced from the end surfaces 2a and 2b and the side surfaces 2e and 2f of the element body 2. One end portion 6a in the extending direction of each of the second wiring portions 6 is located near the end surface 2a, and the other end portion 6b is located near the end surface 2b. The second wiring portions 6 are located on the main surface 2c side of the element body 2 because the element layer 22 is laminated directly on the element layer 21 constituting the main surface 2c. Hereinafter, the element layer 22 is also referred to as a first element layer.

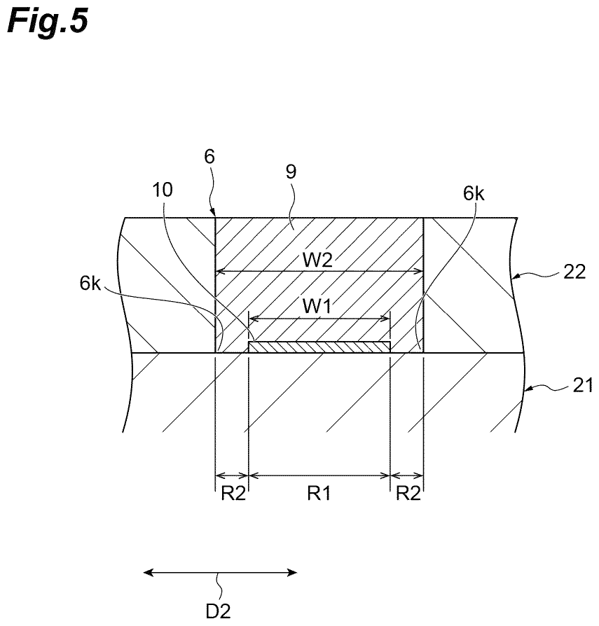

As shown in FIG. 5, each of the second wiring portions 6 has a substantially rectangular shape in a cross section orthogonal to the extending direction (i.e., the first direction D1), and has four corner portions including two corner portions 6k in contact with the element layer 21 (first insulating layer). Each of the second wiring portions 6 includes a main body 9 and an adhesive layer 10 in the cross section orthogonal to the extending direction. The main body 9 has a substantially rectangular cross-sectional shape and is composed of metal material. In particular, the main body 9 is made of Cu, and is composed of Cu plating in particular. The adhesive layer 10 is interposed in a part of an interface between the main body 9 and the element layer 21. The adhesive layer 10 is a thin layer and is composed of metal material. In particular, the adhesive layer 10 is made of material having a higher adhesive force to the element layer 21 than material of the main body 9, and is made of Cr in particular. By interposing the adhesive layer 10 at the interface between the main body 9 and the element layer 21, the adhesive force of the second wiring portion 6 to the element layer 21 is enhanced as compared with a case where the adhesive layer 10 is not interposed. When the main body 9 is formed by electrolytic plating, the adhesive layer 10 can be used as a seed layer. At that time, if necessary, a coating layer covering the surfaces of the adhesive layer 10 and the element layer 21 may be formed by Cu sputtering.

As shown in FIG. 5, a second direction length W1 of the adhesive layer 10 is shorter than a second direction length W2 of the main body 9. Therefore, there exist a first region R1 where the adhesive layer 10 and the element layer 21 are in direct contact with each other, and second regions R2 where the main body 9 and the element layer 21 are in direct contact with each other. In particular, there exist one of the first region R1 and a pair of the second regions R2 sandwiching the first region R1 in the second direction D2. Therefore, both of the corner portions 6k of the second wiring portion 6 in contact with the element layer 21 correspond to the second region R2 and are composed of the main body 9 (i.e., the corner portions 6k are made of Cu of the main body 9).

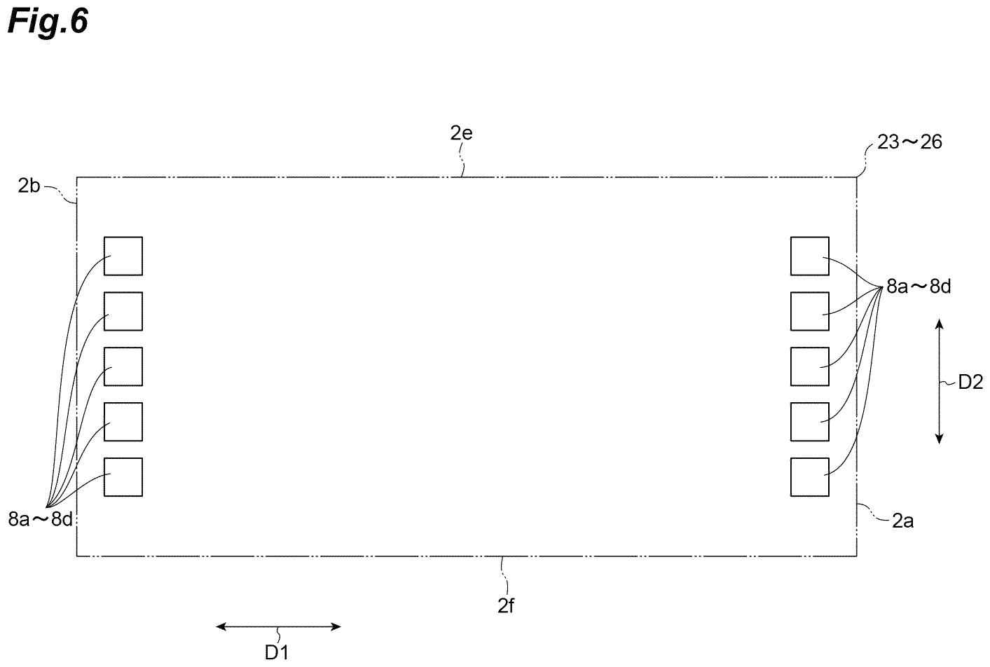

In the element layers 23 to 26, as shown in FIGS. 3 and 6, wiring portions 8a to 8d (pillar conductors) constituting the pillar portion 8 extending along the third direction D3 are embedded. The wiring portions 8a to 8d are provided at the same position in each of the element layers 23 to 26 and overlap each other in the third direction D3. Hereinafter, the element layers 23 to 26 are also referred to as second element layers.

Each of the wiring portions 8a to 8d is composed of a plurality of pairs with respect to the first direction D1, and is composed of five pairs in the present embodiment. In particular, each of the wiring portions 8a to 8d is aligned in two rows along the second direction D2 and are equally spaced with respect to the second direction D2. Hereinafter, of the wiring portions 8a to 8d aligned in two rows, the row on the end surface 2a side is also referred to as a first row 8A, and the row on the end surface 2b side is also referred to as a second row 8B. The wiring portions 8a to 8d at the first row 8A are arranged at positions corresponding to the end portions 6a of the second wiring portions 6, and the wiring portions 8a to 8d at the second row 8B are arranged at positions corresponding to the end portions 6b of the second wiring portions 6. In the present embodiment, each of the wiring portions 8a to 8d has a substantially rectangular shape (for example, a substantially square shape) when viewed from the third direction D3. Each of the wiring portions 8a to 8d may have a circular shape, an elliptical shape, or a polygonal shape other than a square shape when viewed from the third direction D3.

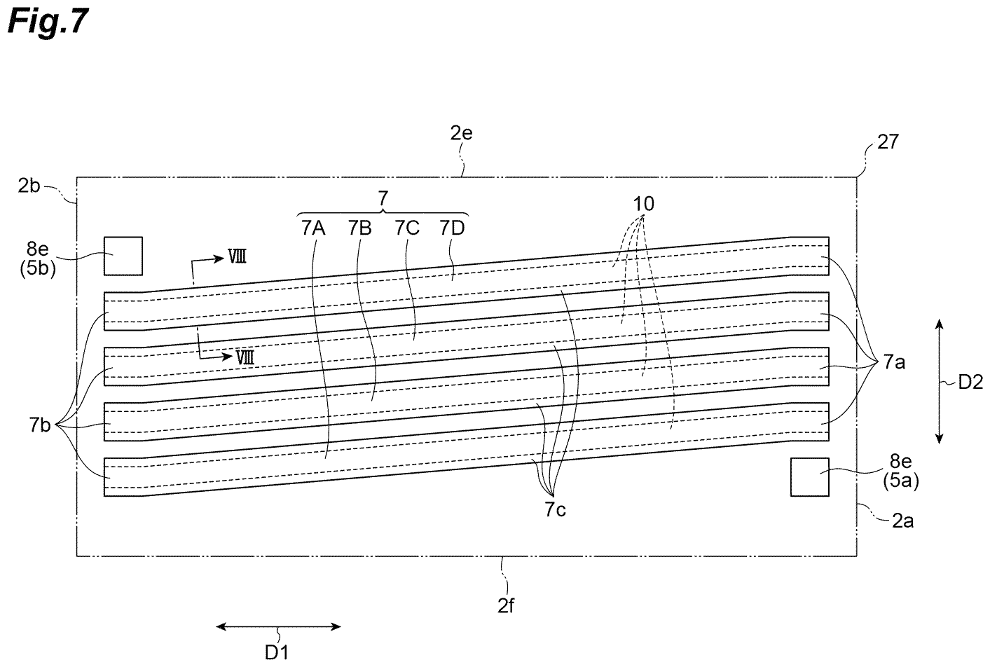

In the element layer 27, as shown in FIGS. 3 and 7, a plurality of first wiring portions 7 are embedded, and the element layer 27 includes four of the first wiring portions 7 in the present embodiment. Hereinafter, the element layer 27 is also referred to as a third element layer. Each of the first wiring portions 7 has a pair of end portions 7a and 7b, and an inclined portion 7c interposed between the pair of the end portions 7a and 7b. The pair of the end portions 7a and 7b, and the inclined portion 7c are configured to be continued, and the pair of the end portions 7a and 7b are located on both sides of the inclined portion 7c with respect to the first direction D1. The pair of the end portions 7a and 7b are composed of a first end portion 7a located closer to the end surface 2a of the element body 2, and a second end portion 7b located closer to the end surface 2b of the element body 2. The pair of the end portions 7a and 7b are offset from each other with respect to the second direction D2 when viewed from the third direction D3. In the present embodiment, the first end portion 7a is located closer to the side surface 2f than the second end portion 7b when viewed from the third direction D3. The inclined portion 7c extends in a direction inclined at a predetermined angle with respect to the first direction D1 and connects the pair of the end portions 7a and 7b that are offset from each other with respect to the second direction D2. The inclination angle with respect to the first direction D1 is the same for all the first wiring portions 7. That is, the inclined portions 7c of the first wiring portions 7 have a parallel relationship with each other. In the present embodiment, four of the first wiring portions 7 are composed of a first wiring portion 7A, a first wiring portion 7B, a first wiring portion 7C, and a first wiring portion 7D arranged in order from the side closer to the side surface 2f.

The first end portion 7a of the first wiring portion 7 overlaps with one of the wiring portions 8a to 8d at the first row 8A and one of the end portions 6a of the second wiring portions 6 when viewed from the third direction D3. The second end portion 7b of the first wiring portion 7 overlaps with one of the wiring portions 8a to 8d at the second row 8B and one of the end portions 6b of the second wiring portions 6 when viewed from the third direction D3. In the present embodiment, the second end portion 7b of the first wiring portion 7A overlaps with the first of the wiring portions 8a to 8d at the second row 8B counted from the side surface 2f side and overlaps with the end portion 6b of the first of the second wiring portions 6 counted from the side surface 2f side, and the first end portion 7a overlaps with the second of the wiring portions 8a to 8d at the first row 8A counted from the side surface 2f side and overlaps with the end portion 6a of the second of the second wiring portions 6 counted from the side surface 2f side. The second end portion 7b of the first wiring portion 7B overlaps with the second of the wiring portions 8a to 8d at the second row 8B counted from the side surface 2f side and overlaps with the end portion 6b of the second of the second wiring portions 6 counted from the side surface 2f side, and the first end portion 7a overlaps with the third of the wiring portions 8a to 8d at the first row 8A counted from the side surface 2f side and overlaps with the end portion 6a of the third of the second wiring portions 6 counted from the side surface 2f side. The second end portion 7b of the first wiring portion 7C overlaps with the third of the wiring portions 8a to 8d at the second row 8B counted from the side surface 2f side and overlaps with the end portion 6b of the third of the second wiring portions 6 counted from the side surface 2f side, and the first end portion 7a overlaps with the fourth of the wiring portions 8a to 8d at the first row 8A counted from the side surface 2f side and overlaps with the end portion 6a of the fourth of the second wiring portions 6 counted from the side surface 2f side. The second end portion 7b of the first wiring portion 7D overlaps with the fourth of the wiring portions 8a to 8d at the second row 8B counted from the side surface 2f side and overlaps with the end portion 6b of the fourth of the second wiring portions 6 counted from the side surface 2f side, and the first end portion 7a overlaps with the fifth of the wiring portions 8a to 8d at the first row 8A counted from the side surface 2f side and overlaps with the end portion 6a of the fifth of the second wiring portion 6 counted from the side surface 2f side.

Each of the first wiring portions 7, similar to the second wiring portions 6, has a substantially rectangular shape in a cross section orthogonal to the extending direction, and has four corner portions including two corner portions 7k in contact with the element layer 26 (first insulating layer). Each of the first wiring portions 7, similar to the second wiring portions 6, includes a main body 9 and an adhesive layer 10 in a cross section orthogonal to the extending direction. The main body 9 has a substantially rectangular cross-sectional shape and is composed of metal material. In particular, the main body 9 is made of Cu, and is composed of Cu plating in particular. The adhesive layer 10 is interposed in a part of an interface between the main body 9 and the element layer 26. The adhesive layer 10 is a thin layer and is composed of metal material. In particular, the adhesive layer 10 is made of material having a higher adhesive force to the element layer 26 than material of the main body 9, and is made of Cr in particular. By interposing the adhesive layer 10 at the interface between the main body 9 and the element layer 26, the adhesive force of the first wiring portion 7 to the element layer 26 is enhanced as compared with a case where the adhesive layer 10 is not interposed. When the main body 9 is formed by electrolytic plating, the adhesive layer 10 can be used as a seed layer. At that time, if necessary, a coating layer covering the surfaces of the adhesive layer 10 and the element layer 26 may be formed by Cu sputtering.

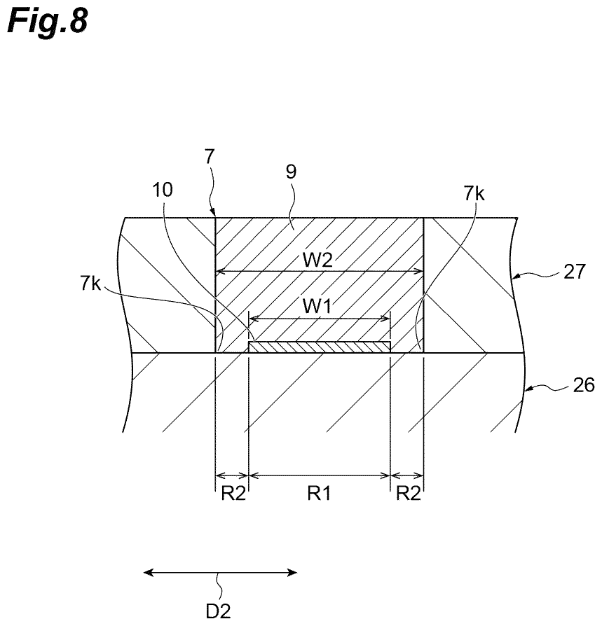

As shown in FIG. 8, a second direction length W1 of the adhesive layer 10 is shorter than a second direction length W2 of the main body 9. Therefore, there exist a first region R1 where the adhesive layer 10 and the element layer 21 are in direct contact with each other, and second regions R2 where the main body 9 and the element layer 26 are in direct contact with each other. In particular, there exist one of the first region R1 and a pair of the second regions R2 sandwiching the first region R1 in the second direction D2. Therefore, both of the corner portions 7k of the first wiring portion 7 in contact with the element layer 26 correspond to the second region R2 and are composed of the main body 9 (i.e., the corner portions 7k are made of Cu of the main body 9).

Further, a pair of the wiring portions 8e (first extracting wiring portions) are embedded in the element layer 27. One of the pair of wiring portions 8e is provided at a position overlapping one of the wiring portions 8a to 8d at the first row 8A, and the other of the pair of wiring portions 8e is provided at a position overlapping one of the wiring portions 8a to 8d at the second row 8B. In the present embodiment, one of the pair of the wiring portions 8e overlaps with the first of the wiring portions 8a to 8d at the first row 8A counted from the side surface 2f side and overlaps with the end portion 6a of the first of the second wiring portions 6 counted from the side surface 2f side, and constitutes an end portion 5a of the coil conductor 5. The other of the pair of the wiring portions 8e overlaps with the fifth of the wiring portions 8a to 8d at the second row 8B counted from the side surface 2f side and overlaps with the end portion 6b of the fifth of the second wiring portions 6 counted from the side surface 2f side, and constitutes an end portion 5b of the coil conductor 5.

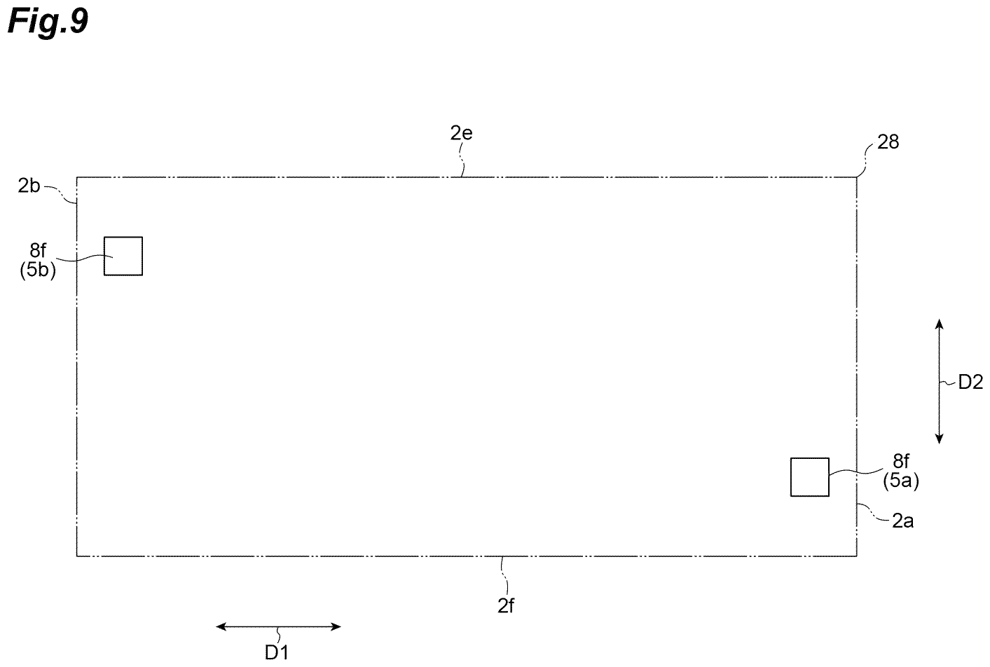

As shown in FIGS. 3 and 9, a pair of the wiring portions 8f (second extracting wiring portions) are embedded in the element layer 28. The pair of the wiring portions 8f are provided at positions respectively overlapping the pair of the wiring portions 8e of the element layer 27. The wiring portion 8f on the end surface 2a side and the side surface 2f side constitutes the end portion 5a of the coil conductor 5, and the wiring portion 8f on the end surface 2b side and the side surface 2e side constitutes the end portion 5b of the coil conductor 5. Hereinafter, the element layer 28 is also referred to as a fourth element layer.

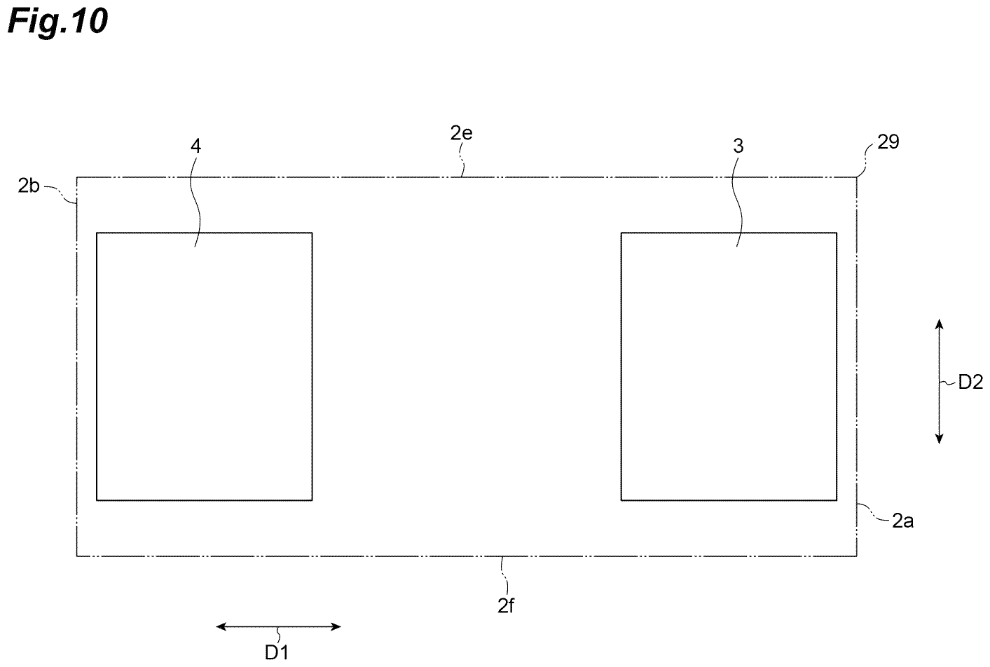

As shown in FIGS. 3 and 10, the pair of the bottom electrodes 3 and 4 (terminal electrodes) are provided in the element layer 29. The element layer 29 is located at the top of the element body 2 in view of the manufacturing procedure, and the element layer 29 constitutes the main surface 2d. In other words, the pair of the bottom electrodes 3 and 4 are provided in the main surface 2d of the element body 2. Hereinafter, the element layer 29 is also referred to as a fifth element layer. Each of the pair of the bottom electrodes 3 and 4 has a rectangular shape when viewed from the third direction D3. The pair of the bottom electrodes 3 and 4 may have the same shape and the same dimensions. The pair of the bottom electrodes 3 and 4 according to the present embodiment are arranged in the first direction D1, the bottom electrode 3 located closer to the end surface 2a of the element body 2 overlaps with the wiring portion 8f in the element layer 28 closer to the end surface 2a and the side surface 2f, and the bottom electrode 4 located closer to the end surface 2b of the element body 2 overlaps with the wiring portion 8f in the element layer 28 closer to the end surface 2b and the side surface 2e. The pair of the bottom electrodes 3 and 4 are embedded in the element body 2 (more specifically, inside the element layer 29) and are exposed from the main surface 2d. A part or a whole of the bottom electrodes 3 and 4 may be provided on the main surface 2d of the element body 2.

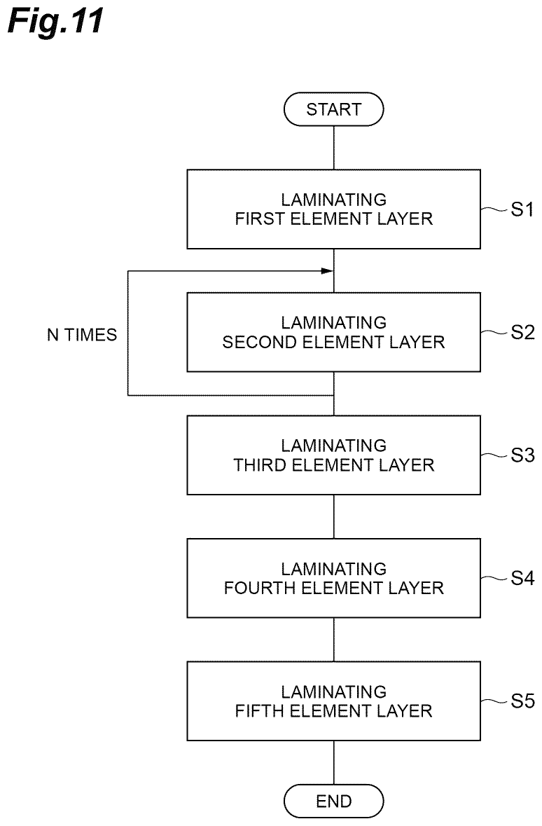

The coil component 1 can be manufactured by the manufacturing method shown in the flowchart of FIG. 11.

First, the first element layer 22 is laminated on the element layer 21 as a first step S1. In particular, the second wiring portions 6 are formed on the element layer 21, and then the second wiring portions 6 are embedded with resin material constituting the first element layer 22. In particular, resist partition walls are provided on the element layer 21, the main body 9 is formed by electrolytic plating using the adhesive layer 10 as a seed layer between the resist partition walls, and then the resist partition walls are removed to obtain the second wiring portion 6.

Next, as a second step S2, the second element layers 23 to 26 are sequentially laminated on the first element layer 22. When the second element layers 23 to 26 are composed of a plurality of layers as in the present embodiment, the second step S2 is repeated a plurality of times. That is, when the number of the second element layers is N, the second step S2 is repeated N times. When the second element layer is a single layer, the second step S2 is performed only once and does not need to be repeated.

Thereafter, as a third step S3, the third element layer 27 is laminated on the second element layers 23 to 26 (in particular, on the second element layer 26 located at the top). Specifically, the first wiring portions 7 and the wiring portions 8e are formed on the second element layer 26, and then the first wiring portions 7 and the wiring portions 8e are embedded with resin material constituting the third element layer 27. The first wiring portions 7 are obtained by providing resist partition walls on the second element layer 26, forming the main body 9 by electrolytic plating using the adhesive layer 10 as a seed layer between the resist partition walls, and then removing the resist partition walls.

Further, as a fourth step S4, the fourth element layer 28 is laminated on the third element layer 27. Finally, as a fifth step S5, the fifth element layer 29 is laminated on the fourth element layer 28. The bottom electrodes 3 and 4 may be provided in the fifth element layer 29 before the fifth element layer 29 is laminated, or may be provided in the fifth element layer 29 after the fifth element layer 29 is laminated.

Next, the pillar portion 8 according to the present embodiment will be described with reference to FIGS. 1, 2, and 12.

In the present embodiment, the pillar portion 8 is formed by stacking the wiring portions 8a to 8d of each of the element layers 23 to 26. The pillar portion 8 is composed of a plurality of pairs along the first direction D1, and is composed of five pairs in the present embodiment. Five pairs of the pillar portions 8 are aligned in two rows of the first row 8A and the second row 8B along the second direction D2, same as the wiring portions 8a to 8d.

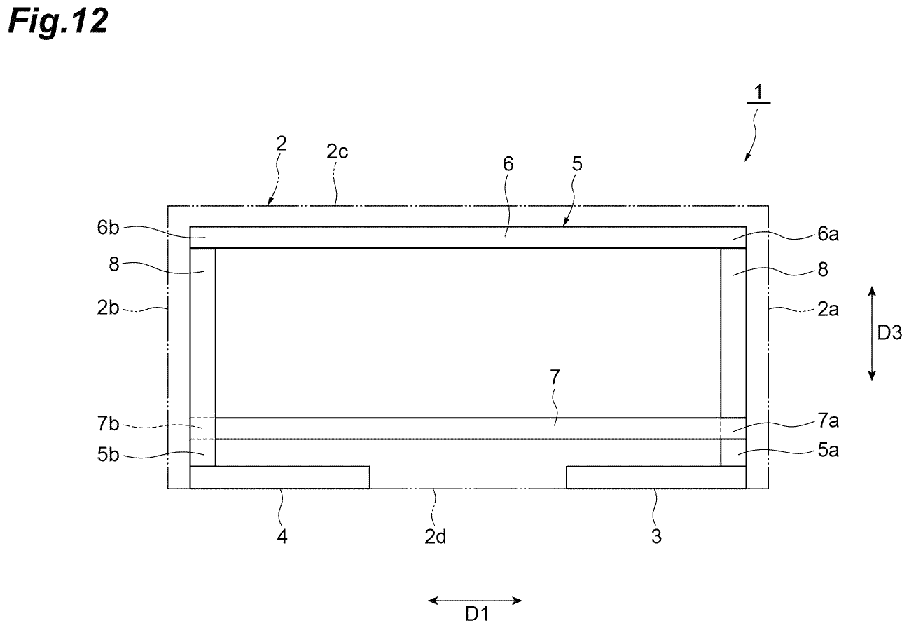

As shown in FIG. 12, each of the pillar portions 8 is connected to both of the end portions 6a and 6b of the second wiring portion 6. In particular, the end portion 6a of the second wiring portion 6 is connected to one end portion of the pillar portion 8 (end portion on the main surface 2c side), and the end portion 6b of the second wiring portion 6 is also connected to one end portion of the pillar portion 8 (end portion on the main surface 2c side). Each of the pillar portions 8 extends from both of the end portions 6a and 6b of the second wiring portion 6 toward the main surface 2d of the element body 2. In other words, one of the second wiring portions 6 is bridged between two of the pillar portions 8.

In the present embodiment, in the first of the pillar portions 8 at the first row 8A counted from the side surface 2f side, one end portion is connected to the end portions 6a of the first of the second wiring portions 6 counted from the side surface 2f side, and the other end portion is connected to the bottom electrode 3 provided in the main surface 2d via the wiring portions 8e and 8f constituting the end portion 5a of the coil conductor 5. In the second to the fifth of the pillar portions 8 at the first row 8A counted from the side surface 2f side, one end portion is respectively connected to the end portions 6a of the second to the fifth of the second wiring portions 6 counted from the side surface 2f side, and the other end portion is respectively connected to the first end portion 7a of the first to the fourth of the first wiring portions 7 counted from the side surface 2f side.

In addition, in the present embodiment, the first to the fourth of the pillar portions 8 at the second row 8B counted from the side surface 2f side have one end portion respectively connected to the end portions 6b of the first to the fourth of the second wiring portions 6 counted from the side surface 2f side, and the other end portion respectively connected to the first to the fourth of the end portions 7 of the first wiring portions 7 counted from the side surface 2f side. The fifth of the pillar portions 8 at the second row 8B counted from the side surface 2f side has one end portion connected to the end portion 6b of the fifth of the second wiring portions 6 counted from the side surface 2f side, and the other end portion connected to the bottom electrode 4 provided in the main surface 2d via the wiring portions 8e and 8f constituting the end portion 5b of the coil conductor 5.

When the above coil component 1 is applied to a high-frequency circuit, a high-frequency current flows intensively near the surfaces of the wiring portions 6 and 7 due to the skin effect, and in the cross sections of the wiring portions 6 and 7 shown in FIGS. 5 and 8, the high-frequency current flows intensively along the outline. Therefore, by reducing the electrical resistance of the outline in the cross sections of the wiring portions 6 and 7, the electrical resistance of the wiring portions 6 and 7 can be effectively reduced.

In the present embodiment, the electrical resistivity of the material constituting the adhesive layer 10 (i.e., Cr) is higher than the electrical resistivity of the material constituting the main body 9 (i.e., Cu). Therefore, as described above, by designing the second direction length W1 of the adhesive layer 10 to be shorter than the second direction length W2 of the main body 9, and by providing the first region R1 where the adhesive layer 10 and the element layers 21 and 26 (first insulating layer) are in direct contact with each other, and the second regions R2 where the main body 9 and the element layers 21 and 26 are in direct contact with each other, a reduction in the electrical resistance of the outline in the cross sections of the wiring portions 6 and 7 is achieved. In the coil component 1, a high self-resonant frequency is realized by achieving a reduction in the electrical resistance in the wiring portions 6 and 7.

Further, as shown in FIGS. 5 and 8, in the wiring portions 6 and 7, the corner portions 6k and 7k in contact with the element layers 21 and 26 are composed of the main body 9, and the electrical resistance of the corner portions 6k and 7k is reduced as compared with a case where the corner portions 6k and 7k are composed of the adhesive layer 10. Since the high-frequency current flows intensively in particular on such corner portions 6k and 7k due to the skin effect, by constituting the corner portions 6k and 7k with material of the main body 9 with a lower electrical resistivity, the electrical resistance in the wiring portions 6 and 7 is further reduced.

The first region R1 and the second region R2 are not limited to the above-described configuration, and can be variously modified. For example, the first region R1 may be arranged to be equidistant from each of the pair of the corner portions 6k and 7k, or may be arranged to be biased toward one of the corner portions 6k and 7k. In this case, one of the corner portions 6k and 7k may be composed of the adhesive layer 10, and only the other of the corner portions 6k and 7k may be composed of the main body 9. In the cross section of each of the wiring portions 6 and 7, the number of the first regions R1 may be one or more. Similarly, in the cross section of each of the wiring portions 6 and 7, the number of the second regions R2 may be one or more.

The present invention is not necessarily limited to the above-described embodiments, and various modifications can be made without departing from the gist thereof.

For example, the configuration in which the first region and the second region exist does not necessarily have to be provided in both of the first wiring portion 7 and the second wiring portion 6, only one of the first wiring portion 7 and the second wiring portion 6 may have the configuration.

What is claimed is:

1. A coil component comprising:
an element body including a plurality of laminated insulating layers;
a coil conductor provided in the element body and including a wiring portion extending in a direction orthogonal to a lamination direction of the element body and overlapping a first insulating layer of the plurality of insulating layers in the lamination direction,
wherein the wiring portion has a main body and an adhesive layer interposed in a part of an interface between the main body and the first insulating layer in a cross section orthogonal to the extending direction, and there exist a first region and a second region, the adhesive layer and the first insulating layer are in direct contact with each other in the first region and the main body and the first insulating layer are in direct contact with each other in the second region.

2. The coil component according to claim 1, wherein an electrical resistivity of the adhesive layer of the wiring portion is higher than an electrical resistivity of the main body.

3. The coil component according to claim 1, wherein the wiring portion has a pair of corner portions in contact with the first insulating layer in a cross section orthogonal to the extending direction, and both of the pair of corner portions are composed of the main body.

4. The coil component according to claim 1, wherein the insulating layer constituting the element body is made of resin.

5. The coil component according to claim 1, wherein the adhesive layer of the wiring portion is made of Cr.

6. The coil component according to claim 1, wherein the main body of the wiring portion is made of Cu.

7. The coil component according to claim 1, wherein the element body has a mounting surface orthogonal to the lamination direction,
wherein the coil conductor includes a plurality of first wiring portions extending in parallel to the mounting surface, a plurality of second wiring portions extending in parallel to the mounting surface on a side farther from the mounting surface than the first wiring portions, and a plurality of pairs of pillar portions extending from both end portions of each of the plurality of second wiring portions toward the mounting surface along the lamination direction, and
wherein the wiring portion is the second wiring portion.
